(19) United States
(12) Patent Application Publication
(10) Pub. No.: US 2004/0179075 A1
(43) Pub. Date: Sep. 16, 2004

(54) Ink-jet recording medium of plain paper type

(76) Inventors: Yuji Ozawa, Tokyo (JP); Akinobu Chatani, Tokyo (JP); Takehiro Yoshimatsu, Tokyo (JP); Noriko Kumazawa, Tokyo (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/479,416

(22) PCT Filed: Jun. 3, 2002
(86) PCT No.: PCT/JP02/05459

(30) Foreign Application Priority Data
Jun. 1, 2001 (JP) 2001-167013
Feb. 22, 2002 (JP) 2002-045772

(51) Int. Cl. G01D 11/00

(52) U.S. Cl. 347/100

(57) ABSTRACT

An inkjet recording medium for plain paper wherein a coating solution having a water-soluble polymer, sizing agent and synthetic resin emulsion as main ingredients is coated or impregnation-coated on at least one surface of a base paper. The synthetic resin emulsion is an emulsion manufactured using 1.5 wt parts or less of a surfactant relative to 100 wt parts of a polymerizing monomer. In this inkjet recording medium, bleeding and feathering do not occur, so the medium is suitable also for multi-color recording.

### FIELD OF THE INVENTION

This invention relates to a plain paper ink-jet recording medium, and in particular to an ink-jet recording medium which gives a high print density without causing bleeding or feathering, and which is also suitable for multi-color recording.

### BACKGROUND OF THE INVENTION

Ink-jet recording media may be broadly divided into the plain paper type which resemble so-called fine quality paper and PPC paper, and the coated paper type which clearly have an ink-receiving layer. Among these, plain paper ink-jet recording media do not have an ink-receiving layer, or even if they do, it is very thin, so they are suitable for electrophotographic recording, or general writing applications with a pencil or pen, and they are also economical.

An ink-jet recording medium is required to have the following performance:

(1): Ink absorptivity must be good. Ink drops adhering to the recording medium surface should penetrate the inside of the base paper rapidly to dry so that they do not contaminate recording apparatus or other media, and are not soiled by handling.

(2): Ink drops should not spread by osmosis in the underlayer or on the surface of the recording medium more than necessary, so that the dots recorded by the ink drops become enlarged or distorted.

If the above performance criteria (1) and (2) are not satisfied, high-definition printing cannot be performed. For example, if the first criterion is not satisfied, not only does contamination occur, but there are blots (bleeding) at the boundaries of different colors in multicolor printing. If the second criterion is not satisfied, print density falls, and as ink is absorbed along the fibers on the paper surface, beard-like smudges (feathering) occur.

In general, in the case of a coated paper ink-jet recording medium, since a porous ink-receiving layer is provided on a substrate, both the first and second qualities can be attained relatively easily. On the other hand, a plain paper ink-jet recording medium does not have an ink-receiving layer, and even if it does, it is only very thin, so it is difficult to simultaneously satisfy the aforesaid two criteria.

However, use of plain paper ink-jet recording media is becoming more common, and in recent years a demand has emerged for plain paper to be capable of the same high quality printing as coated paper. To meet this demand in plain paper type ink-jet recording media, an inkjet recording medium has been proposed wherein, by coating a solution containing a styrene acrylic sizing agent and a water-soluble polymer on a cellulose type base paper and drying, feathering and density unevenness of a print fill part are reduced (JP-A No. 08-216505) and, in JP-A No. 02-188287, an ink-jet recording sheet is disclosed wherein a coating containing a mixture of fine particle anhydrous silica and a cationic polymer is coated or impregnated.

However, even in these inkjet recording media, it was impossible to simultaneously satisfy the aforesaid first and second performance criteria, resolve the problems of bleeding and feathering, and increase the print density.

In general, if the sizing degree of the ink-jet recording medium is increased, the ink drops on the recording medium do not spread so feathering is reduced, but as ink absorption becomes slower, bleeding increases, conversely, if the sizing degree of the inkjet recording medium is reduced, ink absorption is more rapid and bleeding is reduced, but absorption in the horizontal direction of the recording medium also increases, so feathering increases. In other words, feathering and bleeding are contradictory qualities, and both cannot be satisfied simply by adjusting the sizing degree of the inkjet recording paper.

In this connection, the Inventors, after performing intensive studies of plain paper type inkjet recording media satisfying the aforesaid first and second performance criteria, found that satisfactory results can be obtained by incorporating a synthetic emulsion in the recording layer wherein the surfactant amount used in manufacture is sufficiently reduced, and thereby arrived at the present invention.

It is therefore an object of the present invention to provide a regular type ink-jet recording medium which gives high print density without bleeding, and without feathering.

### SUMMARY OF THE INVENTION

The aforesaid object of the present invention is attained by a regular inkjet recording medium wherein a coating solution having a water-soluble polymer, sizing agent and synthetic resin emulsion as its principal components is applied to or impregnated on at least one surface of a base paper, wherein the aforesaid synthetic resin emulsion is an emulsion manufactured using 1.5 wt parts or less of surfactant relative to 100 wt parts of a polymerizing monomer.

According to the present invention, it is preferred that, in the coating solution, (weight percent of surfactant contained in synthetic resin emulsion)×(weight percent of synthetic resin emulsion contained in coating solution) is 300 ppm or less relative to the coating solution, and more preferred that the particle diameter of the synthetic resin emulsion is 100-750 nm. Further, the water-soluble polymer is preferably polyvinyl alcohol. As a result, a recording medium capable of a high print density can be obtained.

Further, the Stöckigt sizing degree of the inkjet recording medium is preferably adjusted so that the value of (Stöckigt sizing degree/(basis weight of recording medium)²)×1000 is 1-10.

### DETAILED DESCRIPTION OF THE INVENTION

The base paper used in the present invention is an uncoated paper having wood cellulose fibers as raw material, this paper being formed mainly of paper-making pulp. Examples of papermaking pulp are chemical pulps such as LBKP, NBKP, and mechanical pulps such as GP, TMP, and recycled paper pulp. This invention is not particularly limited by the aforesaid examples, and these pulps may be used together as necessary. Uncoated paper means paper not having a coating layer containing an ink-absorbing pigment on the surface.

According to the present invention, additives such as filling or sizing agents or paper reinforcing agents added to the base paper are not particularly limited, and may be suitably selected from among the additives known in the art. Also, an antifoaming agent, pH regulating agent, pigment or colored dye to adjust the color tone and fluorescent dye to increase apparent whiteness, may also be added.

The water-soluble polymer used in the coating solution according to the present invention may be suitably selected from among those known in the art which are soluble in water and have film-forming properties. Examples are starch, starch oxide, phosphoric acid esterified starch, cationic starch, fully saponified polyvinyl alcohol, partially saponified polyvinyl alcohol, cation-modified polyvinyl alcohol, silanol-modified polyvinyl alcohol, anion-modified polyvinyl alcohol and casein. According to the present invention, from the viewpoint of increasing print density, the use of polyvinyl alcohol or modified polyvinyl alcohol is preferred.

The synthetic resin emulsion of the present invention is a liquid in which fine particles of a synthetic resin are dispersed in an aqueous solvent, and normally a surfactant or protective colloid is blended therewith to make it more difficult for the fine particles of synthetic resin to stick together in lumps. Also, the method of manufacturing the synthetic resin emulsion may in general be emulsion polymerization, suspension polymerization or dispersion polymerization, but among these, as emulsion polymerization using a surfactant (emulsifying agent) allows easy control of particle diameter, it is suitable for manufacture of the synthetic resin emulsion with a high degree of stability. However, it is difficult to eliminate the surfactant from the emulsified and polymerized synthetic resin emulsion, hence according to the present invention, it is necessary to sufficiently reduce the amount of surfactant used when introducing the starting materials.

For emulsion polymerization, there is a soap-free method which does not use emulsifying agent, but in order to increase the stability of the final product, it is normal even in this case to add a surfactant.

Regarding the synthetic resin emulsion used in the present invention, the surfactant amount used in its manufacture must be no more than 1.5 wt parts, but preferably no more than 1.0 wt parts, relative to 100 wt parts of polymerizing monomer. The composition of the synthetic resin emulsion and its preparation method are not particularly limited provided that aggregation does not occur during manufacture of the synthetic resin emulsion, in the coating solution or on the pulp fiber surface of the base paper. As described later, the synthetic resin emulsion has the effect of supplying voids which assist ink absorption qualities in the ink-receiving layer.

Examples of the polymerizing monomer, surfactant (emulsifying agent) and polymerization initiator which may be used during the manufacture of the synthetic resin emulsion of the present invention, are given below.

The polymerizing monomer may be an aliphatic conjugated di-olefin monomer, cyanated vinyl monomer, mono-olefinic aromatic monomer, ethylenic unsaturated carboxylic acid alkyl ester monomer or olefinic unsaturated carboxylic acid monomer. According to the present invention, these may be used alone, or two or more may be used in combination. Examples of these polymerizing monomers are butadiene, isoprene, 2-chlorobutadiene, acrylonitrile, styrene, α-methyl styrene, chlorostyrene, dimethylstyrene, methyl (meth)acrylate, ethyl (meth)acrylate, butyl (meth)acrylate, 2-ethylhexyl (meth)acrylate, (meth)acrylic acid, crotonic acid, maleic acid, maleic acid alkyl monoester, fumaric acid, fumaric acid alkyl monoester, itaconic acid, itaconic acid alkyl monoester, acrylic acid diglycidyl, acrylic acid hydroxyethyl, acrylic acid hydroxypropyl, acrylamide, N-methylol-acrylamide, N-methoxyacrylamide and vinyl acetate.

The surfactant used in the manufacture of the synthetic resin emulsion of the present invention may be suitably selected from among those known in the art. Examples of this surfactant are anionic surfactants such as alkyl sulfonate, alkyl benzene sulfonate, alkyl allyl sulfonate, alkyl sulfate, alkyl naphthalene sulfonate, alkyl succinate sulfonate and diphenyl ether alkyl sulfonate, non-ionic surfactants such as polyoxyethylene alkylether, polyoxyethylene alkylallylether and polyoxyethylene fatty acid esters, cationic surfactants such as monoalkyl ammonium chloride, dialkyl ammonium chloride and ethylene oxide adduct ammonium chloride. These may be used alone, or two or more may be used in combination. Non-anionic surfactants may act as environmental hormones, and cationic surfactants may require measures to deal with toxicity, so the use of anionic surfactants is preferred. Among anionic surfactants, sodium lauryl sulfate, dodecyl benzene sulfonate and sodium dodecyl sulfate are compatible with most monomers, and may therefore be used widely in the present invention.

The polymerization initiator may be at least one type of oxidizing agent such as potassium persulfate, ammonium persulphate, hydrogen peroxide, diisobutyl benzoyl peroxide, lauryl peroxide and cumene hydroperoxide, and these oxidizing agents may be used in conjunction with sodium sulphite, sodium bisulphite and sodium thiosulfate.

The blending proportion of water-soluble polymer and synthetic resin emulsion according to the present invention is preferably 5 wt parts or more of synthetic resin emulsion, but more preferably 10-100 wt parts, relative to 100 wt parts of water-soluble polymer. If the blending amount of synthetic resin emulsion is less than 5 wt parts relative to 100 wt parts water-soluble polymer, feathering tends to occur. On the other hand, if the blending ratio is greater than 100 wt parts, powder dropping occurs which is a problem.

The surfactant amount from the synthetic resin emulsion in the coating solution is preferably 300 ppm or less, and more preferably 250 ppm or less. By reducing the surfactant amount in the coating solution, a balance can be obtained between feathering and bleeding when the print density is increased.

According to this invention, the particle diameter of the synthetic resin emulsion is not particularly limited, but is preferably 100 nm or more, and more preferably 250-750 nm. If the particle diameter of the synthetic resin emulsion is less than 100 nm, the surfactant usage amount to achieve stability of the synthetic resin emulsion must be increased, so the effect of the sizing agent added to the coating solution is lost.

The role of the synthetic resin emulsion in the present invention is to make the water-soluble polymer film discontinuous, and to produce visible voids. Therefore, the minimum film-forming temperature of the synthetic resin emulsion is preferably 50° C. or more, so that a film is not formed during ordinary manufacture.

The synthetic resin in the synthetic resin emulsion of the present invention may be a liquid or a solid.

In this way, the problems of feathering and bleeding can both be resolved, and a good ink jet recording medium offering a high print density can be obtained.

Although the reason is not well understood, it appears that the blending of the sizing agent suppresses spreading of the ink in the horizontal direction, and due to the effect of the swelling qualities of the water-soluble polymer itself together with the voids in the water-soluble polymer film formed by the synthetic resin emulsion, the ink penetration rate in the recording medium increases. Consequently, ink drops which are printed on the recording medium can penetrate the recording medium to a suitable degree without spreading in a horizontal direction.

According to the present invention, a sizing agent known in the art is added to the coating solution. Examples of sizing agents which may be used in the present invention may be suitably chosen from among those known in the art including styrene-acrylic sizing agents, acrylic olefin sizing agents, maleic acid sizing agents, silicone water-repellents and fluorinated water-repellents.

According to the present invention, the Stöckigt sizing degree may be adjusted by selecting the addition amount and type of the sizing agent. In order to achieve the object of the present invention, it is particularly preferred that the value of (Stöckigt sizing degree/(basis weight of recording medium)²)×1000 is 1-10.

If the above value is less than 1, the ink penetration rate increases, so ink may penetrate into the interior of the base paper and the print density may fall. Also, the ink may spread more on the recording medium surface, so that it may spread along the fibers and feathering may increase. On the other hand, if the above value is more than 10, the ink penetration rate decreases, and there is a tendency for ink drops to remain longer on the surface. Consequently, in the case of multi-color recording, ink drops of different colors mix together on the recording medium surface, and bleeding may increase. In the ink jet recording medium of the present invention, it is particularly preferred that the value of the Stöckigt sizing degree (seconds)/(basis weight of recording medium (g/m²))² is 3-8. Within this range, a balance can be obtained between feathering and bleeding, print density is high, and a high quality print can be obtained. According to this invention, the sizing degree can be adjusted from the addition amount and/or type of the sizing agent.

In the ink jet recording medium of the present invention, is preferred that the coating solution containing the aforesaid principal components is coated to give 0.5-5.0 g/m² in terms of solids on each surface of the medium. If the coating amount is within this range, a recording medium close to the quality of ordinary paper can be obtained. If the coating amount is less than 0.5 g/m², it may be difficult to hold the ink on the paper surface, and also, there is a tendency for resolution to fall and print density to fall. On the other hand, if the coating amount is more than 5.0 g/m², it becomes difficult to achieve the quality of plain paper, and also, there is a tendency for ink absorption capacity to become excessive and print density to fall.

The coating solution may contain additives generally used in the art such as a dye, water retention agent, waterproofing agent, fluorescent whitening agent, pH regulating agent, antifoaming agent, lubricant, preservative, surfactant and electrically conducting agent. The coating solution also preferably should not contain pigments affecting ink absorption (specifically, porous pigments such as powdered silica and alumina, colloidal silica and alumina sol). If these pigments are added to the coating solution, the ink is absorbed by the pigment, so print density falls.

The ink jet recording medium according to the present invention may be manufactured by an impregnation method or coating method known in the art, such as impregnating the base paper with the aforesaid coating solution and drying, or coating it onto the base paper surface and drying. The impregnation method may employ an impregnation type size press apparatus, and the coating method may employ a coating apparatus known in the art such as a blade coater, roll coater, air knife coater, bar coater, curtain coater, photogravure coater or gate roll coater.

The drying method may employ an ordinary heating means such as for example a vaporizing heater, gas heater, infrared heater, electric heater, hot air heater, microwave or cylinder drier. After drying, a smoothing quality may if necessary be imparted by a finishing step such as a super calendar or soft calendar. In addition, according to this invention, plain paper treatments may be used as appropriate.

Thus, according to the present invention as described hereinabove, feathering and bleeding can simultaneously be suppressed, and a good ink jet recording medium offering high print density is obtained. This is considered to be due to the fact that not only is ink spreading in the horizontal direction suppressed due to the blending of the sizing agent, but due to the synthetic resin emulsion, discontinuities in the water-soluble polymer film on the pulp fiber surface are formed so as to create voids, therefore, the ink penetration rate in the recording medium increases, and the ink penetrates the recording medium to a suitable degree without ink drops printed on the recording medium spreading in a horizontal direction. However, if the surfactant addition amount used in the manufacture of the synthetic resin emulsion is large, the effect of the sizing agent is lost, feathering occurs and print density declines.

In the ink jet recording medium of the present invention, feathering and bleeding are reduced, and a recorded image can be obtained with a high print density which is suitable for multi-color recording. Further, as the quality of plain paper can be retained, the medium may be applied also to electrophotographic recording or to ordinary writing applications such as writing with a pencil.

### EXAMPLES

This invention will now be described in more detail referring to specific examples, but it should be understood that the invention is not to be construed as being limited in any way thereby. In the examples, “parts” and “%” refer to “wt parts” and “wt %” unless otherwise specified.

(Manufacture of Synthetic Resin Emulsion A)

75 parts of de-ionized water, 0.05 parts of sodium lauryl sulfate and 0.6 parts of potassium persulphate were introduced into an autoclave fitted with a stirrer under a current of nitrogen, and the temperature was raised to 70° C. At the same time, 45 parts of de-ionized water, 0.5 parts of sodium lauryl sulfate, 0.5 parts of tertiary mercaptan, and a total of 100 parts of polymerizing resin monomers (10 parts of butadiene, 65 parts of styrene, 20 parts of methyl methacrylate, 2 parts of methacrylic acid, 1 part of itaconic acid and 2 parts of acrylamide), were introduced into another autoclave fitted with a stirrer under a current of nitrogen, emulsified and dispersed, and the temperature was raised to 70° C. This emulsion was gradually introduced continuously into the aforesaid aqueous solution, polymerized while maintaining the temperature at 70° C., and when the polymerization rate exceeded 98%, the mixture was cooled and the reaction stopped. Next, the pH was adjusted to 8 using a 25% aqueous solution of caustic soda, and steam stripping was performed to remove unreacted material. The excess water was evaporated under vacuum using an evaporator, and the solids were adjusted to 48% so as to obtain a synthetic resin emulsion A.

(Manufacture of Synthetic Resin Emulsion B)

75 parts of de-ionized water, 0.05 parts of sodium lauryl sulfate and 0.6 parts of potassium persulphate were introduced into an autoclave fitted with a stirrer under a current of nitrogen, and the temperature was raised to 70° C. At the same time, 45 parts of de-ionized water, 1.0 parts of sodium lauryl sulfate, 0.5 parts of tertiary mercaptan, and a total of 100 parts of polymerizing resin monomers (10 parts of butadiene, 65 parts of styrene, 20 parts of methyl methacrylate, 2 parts of methacrylic acid, 1 part of itaconic acid and 2 parts of acrylamide), were introduced into another autoclave fitted with a stirrer under a current of nitrogen, emulsified and dispersed, and the temperature was raised to 70° C. This emulsion was gradually introduced continuously into the aforesaid aqueous solution, polymerized while maintaining the temperature at 70° C., and when the polymerization rate exceeded 98%, the mixture was cooled and the reaction stopped. Next, the pH was adjusted to 8 using a 25% aqueous solution of caustic soda, and steam stripping was performed to remove unreacted material. The excess water was evaporated under vacuum using an evaporator, and the solids were adjusted to 48% so as to obtain a synthetic resin emulsion B.

(Manufacture of Synthetic Resin Emulsion C)

75 parts of de-ionized water, 0.05 parts of sodium lauryl sulfate and 0.6 parts of potassium persulphate were introduced into an autoclave fitted with a stirrer under a current of nitrogen, and the temperature was raised to 70° C. At the same time, 45 parts of de-ionized water, 1.4 parts of sodium lauryl sulfate, 0.5 parts of tertiary mercaptan, and a total of 100 parts of polymerizing resin monomers (10 parts of butadiene, 65 parts of styrene, 20 parts of methyl methacrylate, 2 parts of methacrylic acid, 1 part of itaconic acid and 2 parts of acrylamide), were introduced into another autoclave fitted with a stirrer under a current of nitrogen, emulsified and dispersed, and the temperature was raised to 70° C. This emulsion was gradually introduced continuously into the aforesaid aqueous solution, polymerized while maintaining the temperature at 70° C., and when the polymerization rate exceeded 98%, the mixture was cooled and the reaction stopped. Next, the pH was adjusted to 8 using a 25% aqueous solution of caustic soda, and steam stripping was performed to remove unreacted material. The excess water was evaporated under vacuum using an evaporator, and the solids were adjusted to 48% so as to obtain a synthetic resin emulsion C.

(Manufacture of Synthetic Resin Emulsion D)

75 parts of de-ionized water, 0.05 parts of sodium lauryl sulfate and 0.6 parts of potassium persulphate were introduced into an autoclave fitted with a stirrer under a current of nitrogen, and the temperature was raised to 70° C. At the same time, 45 parts of de-ionized water, 2.0 parts of sodium lauryl sulfate, 0.5 parts of tertiary mercaptan, and a total of 100 parts of polymerizing resin monomers (10 parts of butadiene, 65 parts of styrene, 20 parts of methyl methacrylate, 2 parts of methacrylic acid, 1 part of itaconic acid and 2 parts of acrylamide), were introduced into another autoclave fitted with a stirrer under a current of nitrogen, emulsified and dispersed, and the temperature was raised to 70° C. This emulsion was gradually introduced continuously into the aforesaid aqueous solution, polymerized while maintaining the temperature at 70° C., and when the polymerization rate exceeded 98%, the mixture was cooled and the reaction stopped. Next, the pH was adjusted to 8 using a 25% aqueous solution of caustic soda, and steam stripping was performed to remove unreacted material. The excess water was evaporated under vacuum using an evaporator, and the solids were adjusted to 48% so as to obtain a synthetic resin emulsion D.

(Manufacture of Base Paper)

8 parts of calcium carbonate as filler, 0.05 parts of an internal sizing agent (Sizepine SA-862: Arakawa Chemicals) and 0.5 parts of cationic starch were added to 100 parts of a pulp slurry comprising broadleaf bleached craft pulp (freeness 350 ml csf), paper was manufactured in a twin wire papermaking machine, and dried and finished by a machine calender to give a base paper of weighting 72 g/m².

### Example 1

An inkjet recording medium according to Example 1 was manufactured by impregnation-coating the base paper manufactured as described above with a coating solution respectively comprising 3% of PVA (PVA 117, Kuraray) in terms of solids, 2.0% of synthetic resin emulsion A and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 110 ppm.

### Example 2

An ink jet recording medium according to Example 2 was manufactured by impregnation-coating the base paper manufactured as described above with a coating solution respectively comprising 3% of PVA (PVA 117, Kuraray) in terms of solids, 2.0% of synthetic resin emulsion A and 0.25% of a sizing agent (Polymalon KB, Arakawa Chemicals) using a sizing press apparatus to give 0.9 g/m² in terms of dry solids, and dried.

### Example 3

An inkjet recording medium according to Example 3 was manufactured by impregnation-coating the base paper manufactured as described above with a coating solution respectively comprising 3% of PVA (PVA 117, Kuraray) in terms of solids, 2.0% of synthetic resin emulsion A and 0.25% of a sizing agent (Polymalon KB, Arakawa Chemicals) using a sizing press apparatus to give 4.3 g/m² in terms of dry solids, and dried.

### Example 4

An inkjet recording medium according to Example 4 was manufactured by impregnation-coating the base paper manufactured as described above with a coating solution respectively comprising 3% of PVA (PVA 117, Kuraray) in terms of solids, 2.0% of synthetic resin emulsion B and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 210 ppm.

### Example 5

An inkjet recording medium according to Example 5 was manufactured by impregnation-coating the base paper manufactured as described above with a coating solution respectively comprising 3% of PVA (PVA 117, Kuraray) in terms of solids, 2.0% of synthetic resin emulsion C and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 280 ppm.

### Example 6

An inkjet recording medium according to Example 6 was manufactured by impregnation-coating the base paper manufactured as described above with a coating solution respectively comprising 3% of PVA (PVA 117, Kuraray) in terms of solids, 0.5% of synthetic resin emulsion C and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 70 ppm.

### Example 7

An inkjet recording medium according to Example 7 was manufactured by impregnation-coating the base paper manufactured as described above with a coating solution respectively comprising 3% of PVA (PVA 117, Kuraray) in terms of solids, 8.0% of synthetic resin emulsion A and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 430 ppm.

### Example 8

An inkjet recording medium according to Example 8 was manufactured by impregnation-coating the base paper manufactured as described above with a coating solution respectively comprising 3% of PVA (PVA 117, Kuraray) in terms of solids, 2.0% of synthetic resin emulsion B and 0.25% of a sizing agent (Polymalon KB, Arakawa Chemicals) using a sizing press apparatus to give 2.5 g/m² in terms of dry solids, and dried. The surfactant amount from the synthetic resin emulsion in this coating solution was 410 ppm.

### Comparative Example 1

An inkjet recording medium according to Comparative Example 1 was manufactured by impregnation-coating the base paper manufactured as described above with a coating solution respectively comprising 3% of PVA (PVA 117, Kuraray) in terms of solids, 2.0% of synthetic resin emulsion D and 0.30% of a sizing agent (Polymalon KB, Arakawa Chemicals) using a sizing press apparatus to give 2.5 g/m² in terms of dry solids, and dried. The surfactant amount from the synthetic resin emulsion in this coating solution was 400 ppm.

### Comparative Example 2

An inkjet recording medium according to Comparative Example 2 was manufactured by impregnation-coating the base paper manufactured as described above with a coating solution respectively comprising 3% of PVA (PVA 117, Kuraray) in terms of solids, and 0.25% of a sizing agent (Polymalon KB, Arakawa Chemicals) using a sizing press apparatus to give 2.5 g/m² in terms of dry solids, and dried.

### Comparative Example 3

The base paper used in Example 1 was taken alone as an inkjet recording medium according to Comparative Example 3.

The composition and Stöckigt sizing degree of the inkjet recording medium obtained in the Examples and Comparative Examples are shown in the following Table. The Stöckigt sizing degree was measured according to JIS-P8122.

| | | | Organic | | | | | | | | Wt. of |
|---|---|---|---|---|---|---|---|---|---|---|---|
| | | | pigment | Sizing | | | | | | | surfactant |
| | | (av.) | (emulsion) | agent | PVA | Coating | Sizing | Sizing | Paper | Surfactant | in coating |
| | | particle | blending | blending | blending | amount | degree, | degree/ | thickness | blending | solution |
| | | diameter | amount | amount | amount | g/m² | sec | Weighting² × 1000 | μm | amount* | (ppm) |
| Ex. 1 | SA | 380 nm | 2.00% | 0.25% | 3% | 2.5 | 21 | 3.8 | 93 | 0.55 | 110 |
| Ex. 2 | SA | 380 nm | 2.00% | 0.25% | 3% | 0.9 | 10 | 1.9 | 92 | 0.55 | 110 |
| Ex. 3 | SA | 380 nm | 2.00% | 0.25% | 3% | 4.3 | 26 | 4.5 | 95 | 0.55 | 110 |
| Ex. 4 | SA | 350 nm | 2.00% | 0.25% | 3% | 2.5 | 20 | 3.6 | 92 | 1.05 | 210 |
| Ex. 5 | SA | 320 nm | 2.00% | 0.25% | 3% | 2.5 | 18 | 3.2 | 93 | 1.45 | 280 |
| Ex. 6 | SA | 320 nm | 0.50% | 0.25% | 3% | 2.5 | 28 | 5.0 | 91 | 1.45 | 70 |
| Ex. 7 | SA | 380 nm | 8.00% | 0.25% | 3% | 2.5 | 6 | 1.1 | 94 | 0.55 | 430 |
| Ex. 8 | SA | 350 nm | 4.00% | 0.25% | 3% | 2.5 | 9 | 1.6 | 93 | 1.05 | 410 |
| Comp. | SA | 310 nm | 2.00% | 0.25% | 3% | 2.5 | 10 | 1.8 | 92 | 2.05 | 400 |
| Ex. 1 | | | | | | | | | | | |
| Comp. | — | — | — | 0.25% | 3% | 2.5 | 21 | 3.8 | 91 | — | — |
| Ex. 2 | | | | | | | | | | | |
| Comp. | — | — | — | — | — | — | 0 | 0.0 | 89 | — | — |
| Ex. 3 | | | | | | | | | | | |

SA: Styrene-acrylic resin, minimum film-forming temperature 85° C.
*wt. parts per 100 of resin component

Table 1 shows the results of print density, feathering and bleeding evaluation for the inkjet recording media obtained in the Examples and Comparative Examples, as below.

(Print Density)

Fill printing (black) was performed with a printer (BJ-F210, Canon), and the print density after 24 hours was measured by a Macbeth densitometer (RD918). In the table, ◯ is 1.3 or more, Δ is from 1.2 to 1.3, and X is less than 1.2.

(Feathering)

A fine black line was printed and recorded by a printer (BJ-F210, Canon), and evaluated visually. ⊚ means not much feathering and very little line broadening, i.e., satisfactory; ◯ means a small amount of feathering and line broadening was observed, but not sufficient to cause a problem, i.e., satisfactory; Δ means there was feathering and line broadening which caused a practical problem; and X means a large amount of feathering and broadening, i.e., unsatisfactory.

(Bleeding)

A black rectangle in the middle of a yellow fill part was recorded by a printer (BJ-F210, Canon), and evaluated visually. ⊚ means not much blurring at the interface, i.e., satisfactory; ◯ means some blurring at the interface was observed, but not sufficient to cause a problem, i.e., satisfactory; Δ means there was blurring at the interface which caused a practical problem; and X means a large amount of blurring at the interface, i.e., unsatisfactory.

TABLE 1

| | Print | | |
|---|---|---|---|
| | density | Feathering | Bleeding |
| Example 1 | 1.34 (◯) | ⊚ | ◯ |
| Example 2 | 1.33 (◯) | ◯ | ◯ |
| Example 3 | 1.35 (◯) | ◯ | ◯ |
| Example 4 | 1.32 (◯) | ◯ | ⊚ |
| Example 5 | 1.31 (◯) | ◯ | ◯ |
| Example 6 | 1.32 (◯) | ◯ | ◯ |
| Example 7 | 1.29 (Δ) | Δ | ⊚ |
| Example 8 | 1.28 (Δ) | Δ | ⊚ |
| Comp. Ex. 1 | 1.25 (Δ) | X | ⊚ |
| Comp. Ex. 2 | 1.36 (◯) | Δ | Δ |
| Comp. Ex. 3 | 1.12 (X) | X | ⊚ |

The results of Table 1 confirm the efficiency of the present invention.

### Example 9

An inkjet recording medium according to Example 9 was manufactured by coating the base paper manufactured as described in Example 1, with a coating solution respectively comprising 3% of PVA (PVA 117, Kuraray) in terms of solids, 1.5% of styrene-acrylic resin particles of particle diameter 500 nm (Glossdale 240-V, Mitsubishi Chemicals aqueous emulsion, minimum film-forming temperature 100° C. or higher), and 0.1% of a sizing agent (Polymalon KB, Arakawa Chemicals) using a sizing press apparatus to give 1.5 g/m² in terms of dry solids, and dried. The Stöckigt sizing degree of this inkjet recording medium was 8 seconds, and the paper thickness was 92 μm.

### Example 10

An inkjet recording medium according to Example 10 was manufactured by coating an identical base paper to that of Example 1, with a coating solution respectively comprising 3% of PVA (PVA 117, Kuraray) in terms of solids, 1.5% of styrene-acrylic resin particles of particle diameter 500 nm (Glossdale 240-V, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 21 seconds, and the paper thickness was 93 μm.

### Example 11

An inkjet recording medium according to Example 11 was manufactured by coating an identical base paper to that of Example 1, with a coating solution respectively comprising 3% of PVA (PVA 117, Kuraray) in terms of solids, 1.5% of styrene-acrylic resin particles of particle diameter 500 nm (Glossdale 240-V, Mitsubishi Chemicals aqueous emulsion, minimum film-forming temperature 100° C. or higher), and 0.8% of a sizing agent (Polymalon KB, Arakawa Chemicals) using a sizing press apparatus to give 1.5 g/m² in terms of dry solids, and dried. The Stöckigt sizing degree of this inkjet recording medium was 41 seconds, and the paper thickness was 91 μm.

### Example 12

An inkjet recording medium according to Example 12 was manufactured by coating an identical base paper to that of Example 1, with a coating solution respectively comprising 3% of PVA (PVA 117, Kuraray) in terms of solids, 1.5% of styrene-acrylic resin particles of particle diameter 300 nm (Variastar UD318, 1.5% of Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 19 seconds, and the paper thickness was 95 μm.

### Example 13

An inkjet recording medium according to Example 13 was manufactured by coating an identical base paper to that of Example 1, with a coating solution respectively comprising 3% of PVA (PVA 117, Kuraray) in terms of solids, 1.5% of styrene-acrylic resin particles of particle diameter 600 nm (Glossdale 205-S, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 25 seconds, and the paper thickness was 93 μm.

### Example 14

An inkjet recording medium according to Example 14 was manufactured by coating an identical base paper to that of Example 1, with a coating solution respectively comprising 3% of PVA (PVA 117, Kuraray) in terms of solids, 1.5% of styrene-acrylic resin particles of particle diameter 500 nm (Glossdale 240-V, Mitsubishi Chemicals aqueous emulsion, minimum film-forming temperature 100° C. or higher), and 0.3% of a sizing agent (Polymalon KB, Arakawa Chemicals) using a sizing press apparatus to give 0.8 g/m² in terms of dry solids, and dried. The Stöckigt sizing degree of this inkjet recording medium was 19 seconds, and the paper thickness was 94 μm.

### Example 15

An inkjet recording medium according to Example 15 was manufactured by coating an identical base paper to that of Example 1, with a coating solution respectively comprising 3% of PVA (PVA 117, Kuraray) in terms of solids, 1.5% of styrene-acrylic resin particles of particle diameter 500 nm (Glossdale 240-V, Mitsubishi Chemicals aqueous emulsion, minimum film-forming temperature 100° C. or higher), and 0.3% of a sizing agent (Polymalon KB, Arakawa Chemicals) using a sizing press apparatus to give 4.5 g/m² in terms of dry solids, and dried. The Stöckigt sizing degree of this inkjet recording medium was 27 seconds, and the paper thickness was 95 μm.

### Example 16

An inkjet recording medium according to Example 16 was manufactured by coating an identical base paper to that of Example 1, with a coating solution respectively comprising 3% of PVA (PVA 117, Kuraray) in terms of solids, 0.5% of styrene-acrylic resin particles of particle diameter 500 nm (Glossdale 240-V, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 20 seconds, and the paper thickness was 911 μm.

### Example 17

An inkjet recording medium according to Example 17 was manufactured by coating an identical base paper to that of Example 1, with a coating solution respectively comprising 3% of PVA (PVA 117, Kuraray) in terms of solids, 3.0% of styrene-acrylic resin particles of particle diameter 500 nm (Glossdale 240-V, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 28 seconds, and the paper thickness was 92 μm.

### Comparative Example 4

To prepare the inkjet recording medium of Comparative Example 4, an identical coating solution to that of Example 1 was used except that it contained 1.4% of a sizing agent (Polymalon KB, Arakawa Chemicals) on an identical base paper to that of Example 1. This coating solution was coated using a sizing press apparatus to give 1.5 g/m² in terms of dry solids, and dried. The Stöckigt sizing degree of this inkjet recording medium was 69 seconds, and the paper thickness was 90 μm.

### Comparative Example 5

An inkjet recording medium according to Comparative Example 5 was manufactured by coating an identical base paper to that of Example 1, with a coating solution respectively comprising 3% of PVA (PVA 117, Kuraray) in terms of solids, 1.5% of styrene-acrylic resin particles of particle diameter 200 nm (Glossdale 204-S, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 10 seconds, and the paper thickness was 92 μm.

### Comparative Example 6

An inkjet recording medium according to Comparative Example 6 was manufactured by coating an identical base paper to that of Example 1, with a coating solution respectively comprising 3% of PVA (PVA 117, Kuraray) in terms of solids, 1.5% of styrene-acrylic resin particles of particle diameter 60 nm (Movinyl 790, Clariant Polymer aqueous emulsion), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 8 seconds, and the paper thickness was 94 μm.

### Comparative Example 7

An inkjet recording medium according to Comparative Example 7 was manufactured by coating an identical base paper to that of Example 1, with a coating solution respectively comprising 3% of PVA (PVA 117, Kuraray) in terms of solids, 1.5% of styrene-acrylic resin particles of particle diameter 1000 nm (Glossdale 110-M, Mitsubishi Chemicals aqueous emulsion, minimum film-forming temperature 100° C. or higher), and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 18 seconds, and the paper thickness was 91 μm.

### Comparative Example 8

An identical base paper to that of Example 1 was taken as the inkjet recording medium of Comparative Example 8. The Stöckigt sizing degree of this inkjet recording medium was 0 seconds, and the paper thickness was 91 μm.

### Comparative Example 9

An inkjet recording medium according to Comparative Example 7 was manufactured by coating an identical base paper to that of Example 1, with a coating solution respectively comprising 3% of PVA (PVA 117, Kuraray) in terms of solids, and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 22 seconds, and the paper thickness was 90 μm.

### Comparative Example 10

An inkjet recording medium according to Comparative Example 10 was manufactured by coating an identical base paper to that of Example 1, with a coating solution respectively comprising 3% of PVA (PVA 117, Kuraray) in terms of solids, 1.5% of colloidal silica (Snowtex N30G, Nissan Chemicals) and 0.3% of a sizing agent (Polymalon KB, Arakawa Chemicals) using a sizing press apparatus to give 1.5 g/m² in terms of dry solids, and dried. The Stöckigt sizing degree of this inkjet recording medium was 13 seconds, and the paper thickness was 93 μm.

The compositions and Stöckigt sizing degrees of the inkjet recording media obtained as in Examples 9-17, and Comparative Examples 4-10, are as shown in the following table.

| | | | Organic | | | | | | | | Wt. of |
|---|---|---|---|---|---|---|---|---|---|---|---|
| | | | pigment | Sizing | | | | | | | surfactant |
| | | (av.) | (emulsion) | agent | PVA | Coating | Sizing | Sizing | Paper | Surfactant | in coating |
| | Organic | particle | blending | blending | blending | amount | degree, | degree/ | thickness | blending | solution |
| | pigment | diameter | amount | amount | amount | g/m² | sec | Weighting² × 1000 | μm | amount* | (ppm) |
| Ex. 9 | SG-240 | 500 nm | 1.50% | 0.10% | 3% | 1.5 | 8 | 1.5 | 92 | 0.3 | 45 |
| Ex. 10 | SG-240 | 500 nm | 1.50% | 0.30% | 3% | 1.5 | 21 | 3.9 | 93 | 0.3 | 45 |
| Ex. 11 | SG-240 | 500 nm | 1.50% | 0.80% | 3% | 1.5 | 41 | 7.6 | 91 | 0.3 | 45 |
| Ex. 12 | SV | 300 nm | 1.50% | 0.30% | 3% | 1.5 | 19 | 3.5 | 95 | 0.5 | 75 |
| Ex. 13 | SG-205 | 600 nm | 1.50% | 0.3 | 3% | 1.5 | 25 | 4.6 | 93 | 0.5 | 75 |
| Ex. 14 | SG-240 | 500 nm | 1.50% | 0.30% | 3% | 0.8 | 19 | 3.6 | 94 | 0.3 | 45 |
| Ex. 15 | SG-240 | 500 nm | 1.50% | 0.30% | 3% | 4.5 | 27 | 4.6 | 95 | 0.3 | 45 |
| Ex. 16 | SG-240 | 500 nm | 0.50% | 0.30% | 3% | 1.5 | 20 | 3.7 | 91 | 0.3 | 15 |
| Ex. 17 | SG-240 | 500 nm | 3.00% | 0.30% | 3% | 1.5 | 28 | 5.2 | 92 | 0.3 | 90 |
| Comp. Ex. 4 | SG-240 | 500 nm | 1.50% | 0 | 3% | 1.5 | 1 | 0.2 | 93 | 0.3 | 45 |
| Comp. Ex. 5 | SG-240 | 500 nm | 1.50% | 1.40% | 3% | 1.5 | 69 | 12.8 | 90 | 0.3 | 45 |
| Comp. Ex. 6 | SG-240 | 200 nm | 1.50% | 0.30% | 3% | 1.5 | 10 | 1.9 | 92 | 0.85 | 127.5 |
| Comp. Ex. 7 | SG-110 | 1000 nm | 1.50% | 0.30% | 3% | 1.5 | 18 | 3.3 | 91 | 0.85 | 127.5 |
| Comp. Ex. 8 | — | — | — | — | — | 0 | 0 | 0.0 | 91 | — | |
| Comp. Ex. 9 | — | — | — | 0.30% | 3% | 1.5 | 22 | 4.1 | 90 | — | |
| Comp. Ex. 10 | CS | 20 nm | 1.50% | 0.30% | 3% | 1.5 | 13 | 2.4 | 93 | — | |

SG-240: Styrene-acrylic resin (Glossdale 240-V), minimum film-forming temperature 100° C.
SG-205: Styrene-acrylic resin (Glossdale 205-S minimum film-forming temperature 100° C.
SV: Styrene-acrylic resin (VariastarUD318) minimum film-forming temperature 100° C.
SG-110: Styrene-acrylic resin (Glossdale 1110-M), minimum film-forming temperature 100° C.
CS: Colloidal silica (Snowtex N30G)
*wt. parts per 100 of resin component

Table 2 shows the results of print density, feathering and bleeding evaluations for these ink-jet recording media as for Example 1.

TABLE 2

| | Print | | |
|---|---|---|---|
| Example | density | Feathering | Bleeding |
| Example 1 | 1.30 (◯) | ◯ | ⊚ |
| Example 2 | 1.35 (◯) | ◯ | ◯ |
| Example 3 | 1.37 (◯) | ⊚ | ◯ |
| Example 4 | 1.34 (◯) | ◯ | ◯ |
| Example 5 | 1.33 (◯) | ◯ | ◯ |
| Example 6 | 1.33 (◯) | ◯ | ◯ |
| Example 7 | 1.36 (◯) | ⊚ | ◯ |
| Example 8 | 1.34 (◯) | ◯ | ◯ |
| Example 9 | 1.35 (◯) | ⊚ | ◯ |
| Comp. Ex. 1 | 1.17 (X) | X | ⊚ |
| Comp. Ex. 2 | 1.39 (◯) | ⊚ | X |
| Comp. Ex. 3 | 1.22 (Δ) | Δ | ⊚ |
| Comp. Ex. 4 | 1.20 (Δ) | X | ⊚ |
| Comp. Ex. 5 | 1.26 (Δ) | Δ | ◯ |
| Comp. Ex. 6 | 1.12 (X) | X | ⊚ |
| Comp. Ex. 7 | 1.33 (◯) | Δ | Δ |
| Comp. Ex. 8 | 1.25 (Δ) | Δ | ◯ |

### INDUSTRIAL FIELD OF APPLICATION

The ink jet recording medium according to the present invention is an inkjet recording medium which in addition to little feathering and bleeding, offers high print density and is suitable for multi-color recording, and as it retains the quality of plain paper, it can also be used for electrophotographic recording and general writing applications with a pencil or the like, so it has a very wide industrial application.

What is claimed is:

1. An inkjet recording medium for plain paper wherein a coating solution having a water-soluble polymer, sizing agent and synthetic resin emulsion as its main ingredients, is coated or impregnation-coated onto at least one surface of a base paper, wherein said synthetic resin emulsion is an emulsion manufactured using 1.5 wt parts or less of surfactant relative to 100 wt parts of a polymerizing monomer.

2. The inkjet recording medium for plain paper according to claim 1, wherein (weight percentage of surfactant contained in synthetic resin emulsion)×(weight percentage of synthetic resin emulsion in coating solution) is 300 ppm or less.

3. The inkjet recording medium for plain paper according to claim 1 or 2, wherein the value of (Stöckigt sizing degree/(basis weight of inkjet recording medium)²)×1000 is 1-10.

4. The inkjet recording medium for plain paper according to any of claims 1-3, wherein the particle diameter of said synthetic resin emulsion is 100-750 nm.

5. The inkjet recording medium for plain paper according to any of claims 1-4, wherein the amount of said synthetic resin emulsion is 5 wt parts or more relative to 100 wt parts of water-soluble polymer.

6. The inkjet recording medium for plain paper according to claim 5, wherein the amount of said synthetic resin emulsion is 5-100 wt parts relative to 100 wt parts of water-soluble polymer.

7. The inkjet recording medium for plain paper according to any of claims 1-6, wherein the water-soluble polymer is polyvinyl alcohol.

8. The inkjet recording medium for plain paper according to any of claims 1-7, wherein the coating amount of said coating solution is 0.5-5.0 g/m² in terms of dry solid.
